(19) United States
(12) Patent Application Publication
(10) Pub. No.: US 2021/0122427 A1
(43) Pub. Date: Apr. 29, 2021

(54) VEHICLE FENDER CAPABLE OF REDUCING THE SPLASHING AND SCATTERING OF WATER DROPS

(71) Applicant: Fu-Man SHIH, New Taipei City (TW)

(72) Inventor: Fu-Man SHIH, New Taipei City (TW)

(21) Appl. No.: 16/868,892

(22) Filed: May 7, 2020

(30) Foreign Application Priority Data
Oct. 28, 2019 (TW) 108214186

(51) Int. Cl. B62D 25/16; B32B 5/02; B32B 5/18; B32B 1/00

(52) U.S. Cl. CPC B62D 25/161; B32B 5/02; B32B 5/18; B32B 2605/08; B32B 2250/02; B32B 2307/726; B32B 1/00

(57) ABSTRACT

A vehicle fender capable of reducing the splashing and scattering of water drops is provided above a tire of the vehicle and comprises an arcuate-shaped main body and an absorbing material layer with a thickness. The arcuate-shaped main body has an upper part and a lower part, and the lower part of the arcuate-shaped main body is provided to face the tire's surface, so as to form a recessed space. The absorbing material layer is connected into the recessed space of the lower part of the arcuate-shaped main body, and the absorbing material layer has a surface provided with a plurality of holes.

### BACKGROUND OF THE INVENTION

### Field of Invention

The present invention is related to a vehicle fender which is capable of reducing the splashing and scattering of water drops, has simple structure and low manufacturing cost, and is particularly suitable for trucks, dump trucks, cars, motorcycles, and even bicycles.

### Prior Art

Conventionally, for vehicles of various kinds, a vehicle fender is usually provided at the main body of a vehicle above its tire, in order to prevent the splash of rainwater, dirty water, or mud and dust from the road surface during the driving of the vehicle. The splash caused by tires of trucks, cars, and trailers would have even worse influence, especially when these vehicles are driven at a high speed in rainy days. Therefore, vehicle fenders are indeed beneficial for driving safety.

A vehicle fender available currently is usually formed as a rigid plate in an arcuate shape made by plastic injection molding. Although such a fender is able to mitigate the problem that rainwater, dirty water, or mud and dust from the road surface are splashed onto the main body of the vehicle or splashed out or scattered around. However, the water on the road would be thrown backwards by the tires of the vehicle at a high speed and hit its fender, so as to form spray due to the rigid property of the fender, which would further impede the sight of the drivers of other vehicles following the vehicle.

### SUMMARY OF THE INVENTION

In view of the shortcomings mentioned above, the present invention is aimed at providing a vehicle fender structurally distinguished from the conventional ones.

An object of the present invention is to provide a vehicle fender that has simple structure, low manufacturing cost, and is capable of reducing the splashing and scattering of water drops.

In order to achieve the above-mentioned object, the present invention provides a vehicle fender capable of reducing the splashing and scattering of water drops, which is provided above one tire of a vehicle and comprises an arcuate-shaped main body and an absorbing material layer with a thickness. The arcuate-shaped main body has an upper part and a lower part, and the lower part of the arcuate-shaped main body is provided to face the tire's surface, so as to form a recessed space. The absorbing material layer is connected into the recessed space of the lower part of the arcuate-shaped main body, and the absorbing material layer has a surface provided with a plurality of holes.

In implementation, the recessed space of the lower part of the arcuate-shaped main body has an inner surface a large area of which is applied with the absorbing material layer.

In implementation, the absorbing material layer is made of sponge, foam, or fabric.

In implementation, the absorbing material layer is adhered into the recessed space of the lower part of the arcuate-shaped main body.

The present invention will become more fully understood by reference to the following detailed description thereof when read in conjunction with the attached drawings.

### BRIEF DESCRIPTION OF THE DRAWINGS

FIG. 1 is a perspective view showing an embodiment of a vehicle fender according to the present invention used for a car.

FIG. 2 is a perspective view showing an embodiment of a vehicle fender according to the present invention used for a bicycle.

FIG. 3 is a partially enlarged view of a part in FIG. 2.

### DETAILED DESCRIPTION OF THE INVENTION

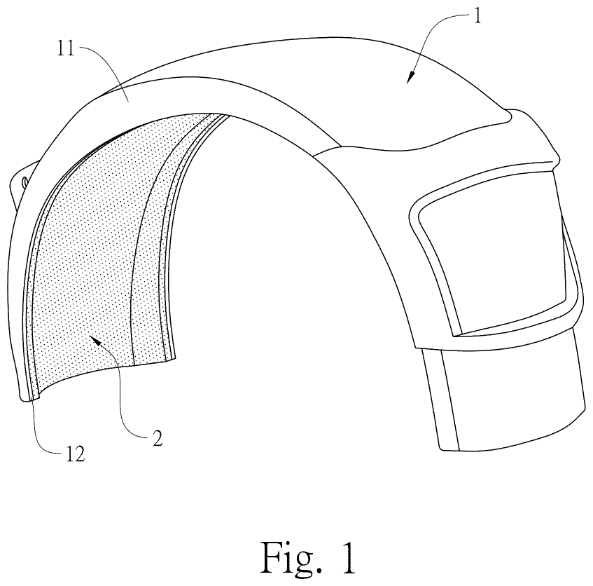

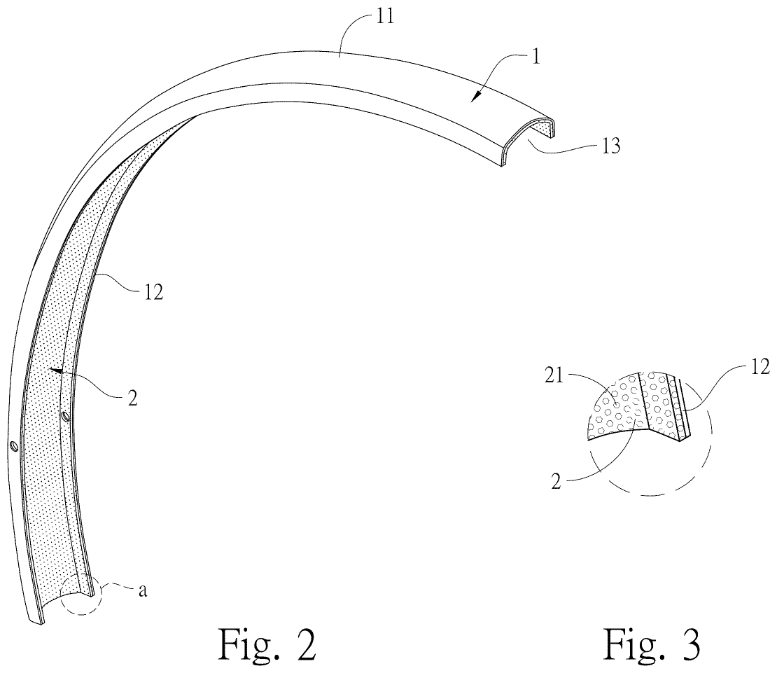

Please refer to FIGS. 1-3, which show an embodiment of a vehicle fender capable of reducing the splashing and scattering of water drops according to the present invention. The vehicle fender in FIG. 1 is used for cars or dump trucks. The vehicle fender in FIG. 2 is used for bicycles. The vehicle fender is provided above one tire of the vehicle and comprises an arcuate-shaped main body 1 and an absorbing material layer 2 with a thickness.

The arcuate-shaped main body 1 of the vehicle fender capable of reducing the splashing and scattering of water drops according to the present invention has an upper part 11 and a lower part 12. The lower part 12 of the arcuate-shaped main body 1 is provided to face the tire's surface, so as to form a recessed space 13.

The absorbing material layer 2 is made of sponge, foam, or fabric, and is connected into the recessed space 13 of the lower part 12 of the arcuate-shaped main body 1. Such connection can be carried out via, but not limited to, adhesion or engagement. Preferably, the absorbing material layer is provided on a large area of the inner surface of the recessed space 13 of the lower part 12 of the arcuate-shaped main body 1. Moreover, the absorbing material layer 2 has a surface provided with a plurality of holes 21, as shown in FIG. 2 and FIG. 3.

In implementation, when people driving vehicles passing by a place where there are puddles in the road or where the road is muddy, or driving vehicles in heavy rain, the puddles, muddy water or rainwater would be drawn off the road and thrown onto the fender. Most of them can be absorbed by the absorbing material layer 2 provided on the large area of the inner surface of the recessed space 13 of the lower part 12 of the arcuate-shaped main body 1. Since the absorbing material layer 2 is made of soft material, such as sponge, foam, or fabric, and has a thickness and a surface provided with a plurality of holes, the puddles, muddy water, or rainwater can be directly absorbed by the absorbing material layer 2 without being splashed and scattered as in the case of conventional vehicle fenders made of hard material. Moreover, when the absorbing material layer 2 reaches its full saturation, the absorbed water would drip from the arcuate-shaped main body 1.

Therefore, according to the present invention, the puddles, muddy water, or rainwater can be absorbed by the absorbing material layer without being splashed and scattered, so as to avoid the formation of spray, and consequently enhance the driving safety.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

In conclusion, according to above-disclosed descriptions, the present invention achieves the expected object to provide a vehicle fender capable of reducing the splashing and scattering of water drops.

What is claimed is:

1. A vehicle fender capable of reducing the splashing and scattering of water drops, provided above one tire of a vehicle, comprising:
an arcuate-shaped main body, having an upper part and a lower part, where the lower part of the arcuate-shaped main body is provided to face the tire's surface, so as to form a recessed space; and
an absorbing material layer with a thickness, for being connected into the recessed space of the lower part of the arcuate-shaped main body, where the absorbing material layer has a surface provided with a plurality of holes.

2. The vehicle fender capable of reducing the splashing and scattering of water drops according to claim 1, wherein the recessed space of the lower part of the arcuate-shaped main body has an inner surface a large area of which is applied with the absorbing material layer.

3. The vehicle fender capable of reducing the splashing and scattering of water drops according to claim 2, wherein the absorbing material layer is adhered into the recessed space of the lower part of the arcuate-shaped main body.

4. The vehicle fender capable of reducing the splashing and scattering of water drops according to claim 1, wherein the absorbing material layer is made of sponge, foam, or fabric.

5. The vehicle fender capable of reducing the splashing and scattering of water drops according to claim 4, wherein the absorbing material layer is adhered into the recessed space of the lower part of the arcuate-shaped main body.

6. The vehicle fender capable of reducing the splashing and scattering of water drops according to claim 1, wherein the absorbing material layer is adhered into the recessed space of the lower part of the arcuate-shaped main body.
